(19) United States
(12) Patent Application Publication
(10) Pub. No.: US 2013/0081085 A1
(43) Pub. Date: Mar. 28, 2013

(54) PERSONALIZED TV LISTING USER INTERFACE

(71) Applicants: Richard Skelton, Los Angeles, CA (US); Jason Rosenthal, Los Angeles, CA (US); Eric Wilson, Los Angeles, CA (US); Patrick Kennedy, West Hollywood, CA (US); Stephanie L. Grossman, Santa Monica, CA (US); Richard Harrison, Dallas, TX (US)

(72) Inventors: Richard Skelton, Los Angeles, CA (US); Jason Rosenthal, Los Angeles, CA (US); Eric Wilson, Los Angeles, CA (US); Patrick Kennedy, West Hollywood, CA (US); Stephanie L. Grossman, Santa Monica, CA (US)

(21) Appl. No.: 13/625,846

(22) Filed: Sep. 24, 2012

Related U.S. Application Data
(60) Provisional application No. 61/538,700, filed on Sep. 23, 2011.

(51) Int. Cl. H04N 21/431

(52) U.S. Cl. 725/46

(57) ABSTRACT

Systems, methods, and media for personalized television listing user interfaces for set top boxes, computers, tablets, mobile phones and other devices. Exemplary methods may include generating a program guide that includes a channel listing, wherein a plurality of channels in the channel listing include broadcast content. Channels in the channel listing are ranked according to preference data for an end user relative to the broadcast content.

### CROSS REFERENCES TO RELATED APPLICATIONS

This application claims the priority benefit of U.S. provisional patent application No. 61/538,700, filed on Sep. 23, 2011 and entitled “Real-time Personalized TV Listing User Interface.” This application is related to the following co-pending and commonly assigned patent applications: application Ser. No. 12/139,384 entitled “Cognitive Scheduler” filed on Jun. 13, 2008, which claims priority benefit of application Ser. No. 61/030,191 entitled “Third Party Content” filed on Feb. 20, 2008 and application Ser. No. 61/035,531 entitled “Cognitive Scheduler for Mobile Platforms” filed on Mar. 10, 2008; application Ser. No. 11/411,066 entitled “System and Method for Consumer Engagement and Revenue Optimization” filed on Apr. 25, 2006, which claims priority benefit of application Ser. No. 60/674,745 entitled “Method for Consumer Engagement and Revenue Optimization” filed on Apr. 25, 2005, application Ser. No. 60/761,840 entitled “System for Deploying Targeted Content in White Space on Wireless Devices” filed on Jan. 25, 2006, application Ser. No. 60/772,770 entitled “System for Deploying Targeted Content in White Space on Wireless Devices” filed on Feb. 13, 2006, and application Ser. No. 60/675,772 entitled “Method for Consumer Engagement and Revenue Optimization” filed on Apr. 28, 2005; application Ser. No. 12/390,310 entitled “Third Party Content Management System and Method” filed on Feb. 20, 2009 which is a continuation in part of application Ser. No. 12/139,394 entitled “Content Management System and Method” filed on Jun. 13, 2008 and application Ser. No. 12/139,384 entitled “Cognitive Scheduler” filed on Jun. 13, 2008, and application Ser. No. 11/411,066 entitled “System and Method for Consumer Engagement and Revenue Optimization” filed on Apr. 25, 2006; and application Ser. No. 12/139,394 entitled “Content Management System and Method” filed on Jun. 13, 2008 which is a continuation in part of application Ser. No. 11/411,066 entitled “System and Method for Consumer Engagement and Revenue Optimization” filed on Apr. 25, 2006. All of the aforementioned disclosures are hereby incorporated herein by reference in their entirety including all references cited therein.

### FIELD OF THE INVENTION

Systems, methods and media are provided herein for personalized TV listing user interfaces (e.g., program guides) for set-top boxes, computers, tablets, mobile phones, and other devices. The program guides generated by the present technology may include a set of dynamically reprioritize grid of broadcast content (e.g., channels, television shows, and other programming) based on the likelihood of a user to consume, watch, and/or engage with such broadcast content.

### BACKGROUND

Currently, TV listing user interfaces or enhanced program guides (EPGs) for set-top boxes, computers, tablets, mobile phones and other devices that display channels and programs (content) in a static grid list arranged by the time of day on one axis and the numerical order of channels available to a subscriber of a cable system on another axis. Users may be able to navigate forward in time on the grid interface to see what will be shown on a certain channel or grouping of channels in the future, and they may navigate through all available channels to see what is on at any given time. Users may also manually enter in a channel number to see what is on that particular channel in the grid listing interface.

There are often hundreds or thousands of channels within a cable system for a user to choose from, and each channel can show a plurality of programs per day. A limitation of current grid-based user interfaces for televisions require that users know what they want to watch and enter the channel number manually, use a search utility, or they must scroll through these hundreds or thousands of channels to discover the programming that they want to watch. Scrolling through these channels is prohibitive, frustrating and time-consuming for the user.

### SUMMARY OF THE PRESENT TECHNOLOGY

According to some embodiments, the present technology may be directed to methods that comprise: (a) ranking, via a personalization system, broadcast content according to preference data for an end user, the broadcast content being ranked in such a way that broadcast content which corresponds more closely to the preferences of the end user is ranked higher than broadcast content which corresponds less to the preferences of the end user; and (b) generating, via user interface module, a program guide that includes a visual representation of the broadcast content, which is hierarchically ranked according to the preference data.

According to exemplary embodiments, the present technology may be directed to systems that comprise: (a) at least one computing device comprising: a memory that includes executable instructions and a processor executing the instructions, the instructions comprising: (i) a personalization engine that ranks broadcast content according to preference data for an end user, the broadcast content being ranked in such a way that broadcast content which corresponds more closely to the preferences of the end user is ranked higher than broadcast content which corresponds less to the preferences of the end user; and (ii) a user interface module that generates a program guide that includes a visual representation of the broadcast content, which has been ranked according to the preference data.

According to some embodiments, the present technology may be directed to methods that comprise at least a step of generating a program guide that includes a channel listing, a plurality of channels in the channel listing comprising broadcast content, wherein channels in the channel listing are ranked according to preference data for an end user relative to the broadcast content.

According to other embodiments, the present technology may be directed to a non-transitory machine-readable medium having embodied thereon a program. In some embodiments the program may be executed by a machine to perform a method. The method may comprise at least a step of generating a program guide that includes a channel listing, a plurality of channels in the channel listing comprising broadcast content, wherein channels in the channel listing are ranked according to preference data for an end user relative to the broadcast content.

### BRIEF DESCRIPTION OF THE DRAWINGS

Certain embodiments of the present technology are illustrated by the accompanying figures. It will be understood that the figures are not necessarily to scale and that details not necessary for an understanding of the technology or that render other details difficult to perceive may be omitted. It will be understood that the technology is not necessarily limited to the particular embodiments illustrated herein.

FIG. 1 is a block diagram of an exemplary architecture in which embodiments of the present technology may be practiced;

FIG. 2 illustrates an exemplary default personalized user interface, also referred to as a program guide;

FIGS. 3A-C collectively illustrate end user selection of a personalized filter for use with various program guides;

FIG. 4A-B collectively illustrate personalized reprioritization of broadcast content across time slots;

FIG. 5 illustrates allocation of personalized slots within an exemplary program guide;

FIG. 6 illustrates the location of allocated and personalized slots within an exemplary program guide;

FIG. 7 illustrates an exemplary computing system that may be used to implement embodiments according to the present technology; and

FIG. 8 is a flowchart of an exemplary method for generating a program guide.

### DESCRIPTION OF EXEMPLARY EMBODIMENTS

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated.

The terminology used herein is for the purpose of describing particular embodiments only and is not intended to be limiting of the invention. As used herein, the singular forms “a”, “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that like or analogous elements and/or components, referred to herein, may be identified throughout the drawings with like reference characters. It will be further understood that several of the figures are merely schematic representations of the present technology. As such, some of the components may have been distorted from their actual scale for pictorial clarity.

Generally speaking, the present technology may be utilized to generate program guides or other ranked listings of broadcast content. In some instances, the program guide may be generated by ranking broadcast content according to preference data, namely end user preference data. The ranked broadcast content may be utilized to generate a program guide that includes a visual representation of the broadcast content in a hierarchical format. The program guide may be then broadcast or otherwise provided to an end user, and specifically to an end user computing device.

The term “broadcasting” may be understood as being defined broadly to encompass one or more of a plurality of processes by which a program guide may be delivered to an end user computing device. Exemplary methods may comprise broadcasting the exemplary program guides or other user interfaces over a network, such as the Internet, or may comprise broadcasting over a wireless network, such as a cellular network. Alternatively, broadcasting may comprise traditional television broadcasting methods using satellites, receivers, fiber optics, or other common media for broadcasting television signals.

The term “broadcast content” is also expansive, comprising any type of content that can be broadcast, including but not limited to, audio signals, video signals, multimedia signals, images, and so forth. Exemplary types of broadcast content comprise television shows, movies, streaming audio and/or video, and so forth. One of ordinary skill in the art will appreciate the vast array of broadcast content that may be provided to an end user computing system using the present technology.

According to some embodiments, programming may, for example, be accessible through a content provider (such as a broadcast system or an Internet service provider “ISP”), or from a personal collection of stored content on a computer, web-enabled television, digital content service, and so forth. Broadcast content may also be digitally encoded and optionally may comprise compressed video and audio (e.g., MPEG-1, MPEG-2, H.264, VC-2, AAC, AC-3, MP3, etc.).

The program guides described herein may comprise various user interfaces that may each comprise a dynamically alterable hierarchy of channels and programs (e.g., broadcast content). The dynamic ordering of channels and their broadcast content within the program guide may be based upon a desire to present the end user with broadcast content that the end user is likely to consume. The likelihood to consume content may also consider relevant time frames such as time of day or day of the week. A user's consumption of content may often comprise watching a program partially or in its entirety, clicking on a program or channel to learn more, saving or recording a program for later viewing, queuing programs, and so forth.

Exemplary embodiments of the program guides of the present technology may be used on a suitable display means, such as a television (optionally in conjunction with a set-top box), desktop computer, notebook computer, netbook computer, tablet computer, smart phone, personal digital assistant, (universal) remote control, and the like. These and other advantages of the present technology will be discussed in greater detail herein.

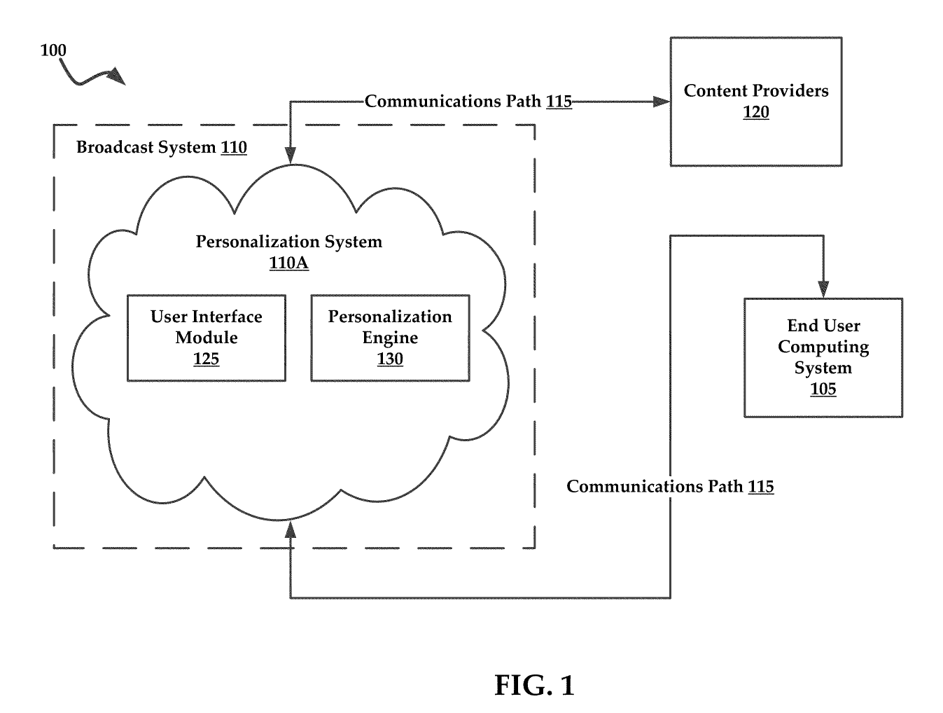

Referring now to the drawings, and more particularly to FIG. 1, there is depicted a schematic diagram of an exemplary architecture 100 for practicing the present invention. In some embodiments, architecture 100 may include an end user computing device (or system) 105, which is communicatively coupled with a broadcast system 110 via a communications path 115. Again, the broadcast system 110 may comprise any suitable system for delivering broadcast content, keeping in mind that broadcast content may comprise any type of content that is “broadcast” over a network connection, although other traditional methods of broadcasting using satellites or antenna transmission are also likewise contemplated for use in accordance with the present technology. Thus, although the communications path 115 is shown as comprising a direct path between the end user computing device 105 and the broadcast system 110, the communications path 115 may comprise a plurality of communications paths that allow for the communication of program guide signals and/or broadcast content signals from the broadcast system 110 to the end user computing device 105.

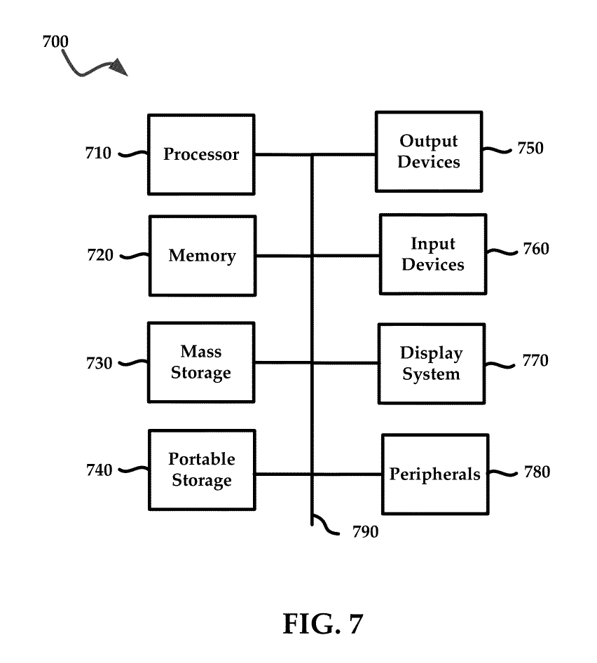

In some instances, the broadcast system 110 may comprise a personalization system 110A. The personalization system 110A may comprise a processor for executing instructions stored in memory of a computing device. The computing device may be a constituent part of the personalization system 110A and may comprise a server or other suitable computing device that may be utilized to deliver broadcast content or a programming guide to the end user computing system 105. Additional details regarding an exemplary computing system are found in FIG. 7, and corresponding disclosure provided below.

According to some embodiments, the personalization system 110A comprises a user interface module 125 and a personalization engine 130. It is noteworthy that the executable instructions may include additional modules, engines, or components, and still fall within the scope of the present technology. As used herein, the term “module” may also refer to any of an application-specific integrated circuit (“ASIC”), an electronic circuit, a processor (shared, dedicated, or group) that executes one or more software or firmware programs, a combinational logic circuit, and/or other suitable components that provide the described functionality. In other embodiments, individual modules may include separately configured web servers. Also, the modules may be provisioned with a cloud.

In some embodiments, the personalization system 110A may be implemented within a cloud-based computing environment. In general, a cloud-based computing environment is a resource that typically combines the computational power of a large model of processors and/or that combines the storage capacity of a large model of computer memories or storage devices. For example, systems that provide a cloud resource may be utilized exclusively by their owners, such as Google™ or Yahoo!™; or such systems may be accessible to outside users who deploy applications within the computing infrastructure to obtain the benefit of large computational or storage resources.

The cloud may be formed, for example, by a network of web servers, with each web server (or at least a plurality thereof) providing processor and/or storage resources. These servers may manage workloads provided by multiple users (e.g., cloud resource consumers or other users). Typically, each user places workload demands upon the cloud that vary in real-time, sometimes dramatically. The nature and extent of these variations typically depend on the type of business associated with the user.

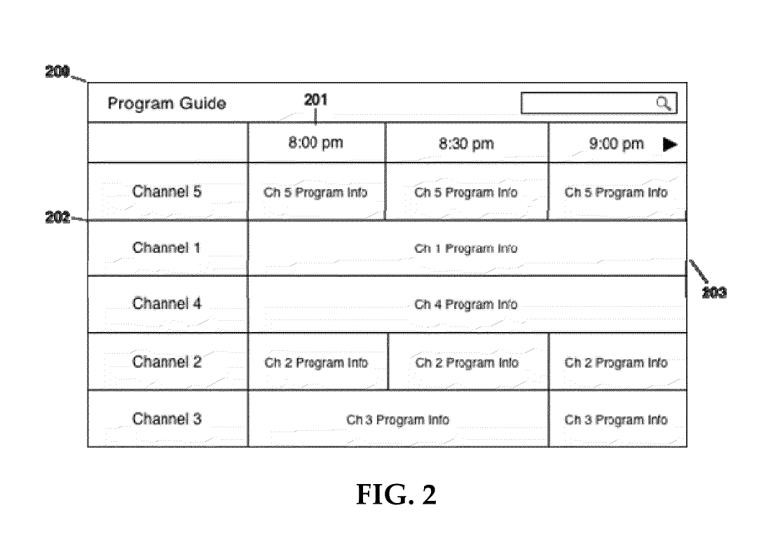

According to some embodiments, the user interface module 125 may be executed to generate various graphical user interfaces. These graphical user interfaces may comprise a visual representation of a ranked list of broadcast content, such as television shows, which have been ranked, not in canonical numerical order relative to channel number, but according to preference data. According to some embodiments, the visual representation may comprise a program guide that comprises a matrix of programs arranged according to channel and time, but where channels have been ranked hierarchically according to preference data. Exemplary user interfaces generated by the user interface module 125 will be described in greater detail below in reference to FIGS. 2-6.

According to some embodiments, the present technology may generate a program guide that includes a channel listing. The channel listing may comprise various channels that have various types of broadcast content associated therewith. In some instances, the channels included in the channel listing are ranked according to preference data for an end user relative to the broadcast content of the channel. That is, channels that include broadcast content that corresponds (at least partially) to the preferences of the end user may be ranked higher on the channel list than channels that include broadcast content that does not correspond well to the preferences of the end user. In some instances, a preference threshold may be utilized. For example, only channels that comprise broadcast content that at least 90% corresponds to the viewing preferences of the end user may be ranked highly. Other channels may be ranked using static slots, as is described in greater detail herein.

Prior to generating and providing program guides or other suitable user interfaces, the personalization engine 130 may be executed to rank the broadcast content according to end user preferences (e.g., preference data). End user preference may be obtained from a wide variety of sources. Non-limiting examples may comprise explicit preference data obtained from end user actions such as deliberate program selection, downloading content, queuing broadcast content, and so forth. Additionally, implicit or incidental preference data may be inferred/obtained by analyzing other types of data such as search engine queries/responses, social media messages, device characteristics and usage patters, and so forth.

According to some embodiments, different types of user viewing behaviors may be evaluated by the personalization engine 130 to generate derived predictions (e.g., implicit or inferred) including, but not limited to, the programs that a user watches, does not watch, records, watches a preview of, rates, and shares on a social network—just to name a few. Viewing behaviors may also include length of the programs the user watches, length of time that the user spends watching, the time of day the user watches, the day of week that the user watches, the origin of the programming the user watches (e.g., live television broadcasts, DVD, video on demand (VOD), and ancillary television services such as Netflix® and Hulu®, and so forth), etc.

Additionally, preference information may be gathered from the type of device the end user utilizes to watch broadcast content, the delivery method of the broadcast content (e.g., streaming video over a network, VOD, pay per view, live television, and so forth), and any combination of the preceding examples or additional examples that would be known to one of ordinary skill in the art. Viewing behaviors may also include the viewing details about the broadcast content the user watches (also what the end user downloads, selects, purchases, queues, etc.) such as the actors, directors, producers, locations, date of origin, as well as the genre, synopsis, theme, mood related details, and any other descriptive information that may be determined about the broadcast content.

Additionally, the personalization engine 130 may determine or infer negative viewing behaviors about an end user. Negative viewing behaviors may include information that an end user does not watch certain programming at certain times of the day and/or day of the week or that the end user does not watch broadcast content that is associated with a certain origin. In other instances, negative viewing behaviors may indicate that the end user does not watch certain broadcast content on a certain devices. For example, the end user may not watch movies on their mobile devices. Other negative viewing behaviors that would be known to one of ordinary skill in the art are likewise contemplated for use in accordance with the present technology.

According to some embodiments, the personalization engine 130 may receive preference data regarding any of the previously described types of end user preference data, namely end user viewing behaviors or anything else. In other instances, the personalization engine 130 may capture end user behaviors by monitoring activity occurring on the end user computing device 105. In some instances, the personalization engine 130 may function as a proxy or intermediary device that receives signals communicated between the broadcast system 110 and the end user computing device 105. The personalization engine 130 may parse these signals to determined end user behavior and generate preference data. In some instances, the personalization engine 130 may render the preference data in a data store, where the preference data may be maintained in a database or individual end user records.

The personalization engine 130 may apply algorithms to the stored user behavioral data, as well as content meta-data, which may persist locally and/or remotely in a data store, for example. The algorithm utilized by the personalization engine 130 may be used to analyze the end user content tastes/preferences and make predictions or recommendations of broadcast content for which the end user is likely to have a preference.

Multiple variables may play a role in the derivation of recommended content by the personalization engine 130. For example, the personalization engine 130 may recommend content that is suited to a particular time of the day and/or day of the week for the end user. The personalization engine 130 may recommend content based on the length of time the user has available to watch content at a particular time of day and/or day of the week. In other instances the personalization engine 130 may recommend content based upon the user's mood at a particular time of day and/or day of the week. In other instances, the personalization engine 130 may automatically queue upcoming programs for recording (such as with a digital video recorder “DVR” or other recording device) if the upcoming programs are determined to be of interest to the end user.

The program guides generated by the personalization engine 130 may be used to present a list of recommended content in ranked order of likelihood to consume/watch for each time slot on the grid. In sum, the recommended content that is include in the program guide may include a personalized selection of content for an individual user at any point in time on the listing interface “grid,” rather than a static numerical ordering of channels and times.

When the user scrolls forward in time on the interface, the personalization engine 130 may alter the hierarchical listing of channels and programs dynamically to increase the likelihood that the user will watch a channel or program include in the listing.

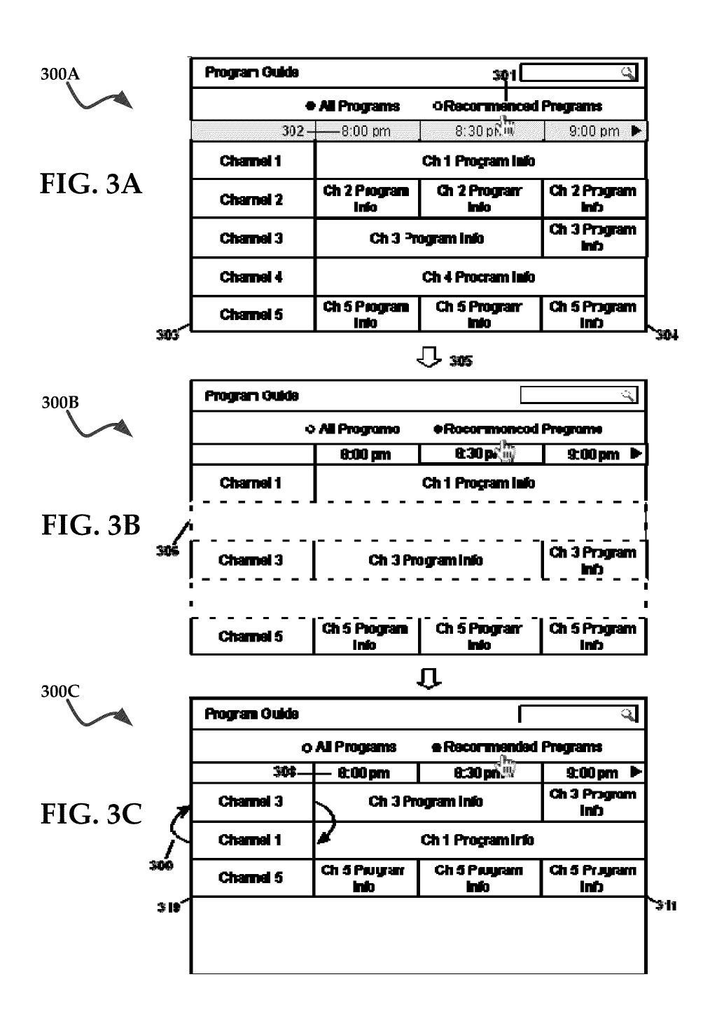

According to some embodiments, the end user may select “recommended” as a selected filter (see FIGS. 3A-C). Upon selection of the filter, the broadcast content included in the program guide may be prioritized or reprioritized based the preferences of the end user. Such prioritization may be executed to provide the end user with broadcast content selections that most closely correspond to the preferences of the end user. Advantageously, the end user may be presented with highly relevant and personalized broadcast content selections rather than being required to utilize complicated search features or manually scrolling through broadcast content selections. In some embodiments, the personalization engine 130 may automatically rank channels in the channel list according to end user preference without requiring the end user to select a “recommendations” filter.

According to some embodiments, a number of “slots” on a program guide that are allocated to channel and program selections derived from the personalization engine 130 may be limited so that only a portion of the grid is reprioritized. The slots before or after the dynamic slots (e.g., designated to be re-prioritized) may default to their normal, un-prioritized order structure, for example by channel number, name, station identification, and the like. Slots that have not been dynamically ranked are referred to as static slots.

A number of “slots” within a program guide that are allocated to channel and program selections may be derived from the personalization engine 130, which may be at the top, middle, bottom or other area within the grid. Thus, the slots before or after those that are designated to be prioritized may default to their normal, un-prioritized order structure, for example by channel number, name, station ID, and the like.

Additionally, the hierarchical ranked listing of broadcast content (or channels) may, in some instances, not be used in the context of a program guide. Ranked lists may be stored in records within a database. These records may be used to create reports that are utilized by broadcasters, advertisers, content authors, or other parties who may benefit from knowing how various types of preference data affect the ranking or ordering of broadcast content. Additionally, the preference data may be applied to broadcast content after the broadcasting of such content, to provide additional ranking information. That is, the ranking of broadcast content need not be executed contemporaneously with the broadcasting of the content.

While some of the above-described embodiments of the present technology contemplate the generation of program guides at the broadcast system 110 or the personalization system 110A, it will be understood that the broadcast system 110 and/or the personalization system 110A may provide a ranked list of channels used to populate the program guide to the end user computing system 105. In some instances, such as with set-top boxes, the end user computing system 105 may generate the program guide at the end user computing system 105, populating the program guide with the received ranked list data.

While many of the embodiments described herein contemplate the use of preference data to generate a program guide for the end user that is utilizing the program guide, it will be understood that the preference data used to generate the program guide may comprise the preference data from other end users. Thus, if the end user utilizing the program desires to see a listing of channels and broadcast content based upon the preferences of another end user, such as a friend, group of friends, a celebrity, or so forth, the preference data used to build the program guide may be obtained from these other parties.

Likewise, a set-top box or other end user computing device may maintain various profiles for end users that utilize the same computing device. Preference data may be stored in a profile for an end user. The profile may be applied to the broadcast content to generate a program guide when the profile is selected by the end user.

FIG. 2 illustrates an exemplary default personalized user interface, also referred to as a program guide 200. The program guide 200 may comprise a current time slot 201 for which broadcast content is prioritized/broadcasted. The program guide 200 comprises a plurality of time slots. Additionally, the program guide 200 may comprise a prioritized list of channels 202 that comprise broadcast content. Scheduling matrix 203 for current and upcoming programming based on preference data for an end user is also shown. The channels listed in the program guide 200 have been prioritized according to end user preference data such that channel 5 is now ranked more highly than channel 1, which indicates that the broadcasting content of channel 5 more closely corresponds to the preferences of the end user as compared to the broadcast content of channel 1.

FIGS. 3A-C collectively illustrate end user selection of a personalized filter for use with a program guide 300A, which is substantially similar to the program guide 200 of FIG. 2. The program guide 300A may comprise a user selectable element 301 (e.g., a radio button) that allows the end user to select preference based sorting. According to some embodiments, the program guide 300A may comprise a plurality of time slots such as a current time slot 302 that comprises broadcast content.

In FIG. 3A, the program guide 300A may initially comprise a static ordering of channels 303. Channels may be arranged into a grid 304 based upon scheduling constraints. The dynamic reorganization of channels within the matrix 304 is represented by arrow 305. Again, this reorganization occurs when end user preferences are used to rank the channels that comprise broadcast content.

In FIG. 3B, it is noteworthy that broadcast content 306 that is not relevant to the current user, as derived by the personalization engine 130, may be removed from the program guide 300B. Thus, the program guide 300B may comprise only personalization engine derived filtered broadcast content in some embodiments.

It is envisioned that the program guide 300C of FIG. 3C may comprise time slots 308 for a prioritized list of broadcast content according to broadcast time. Channel listings and slots 309 of the program guide 300C may comprise broadcast content information which has been dynamically re-ordered to reflect the ranked order of probability of engagement for the current user. Thus, channels 310 may be rearranged according to end user preferences. Additionally, a matrix 311 comprises a schedule for current and upcoming broadcast content based on preference data.

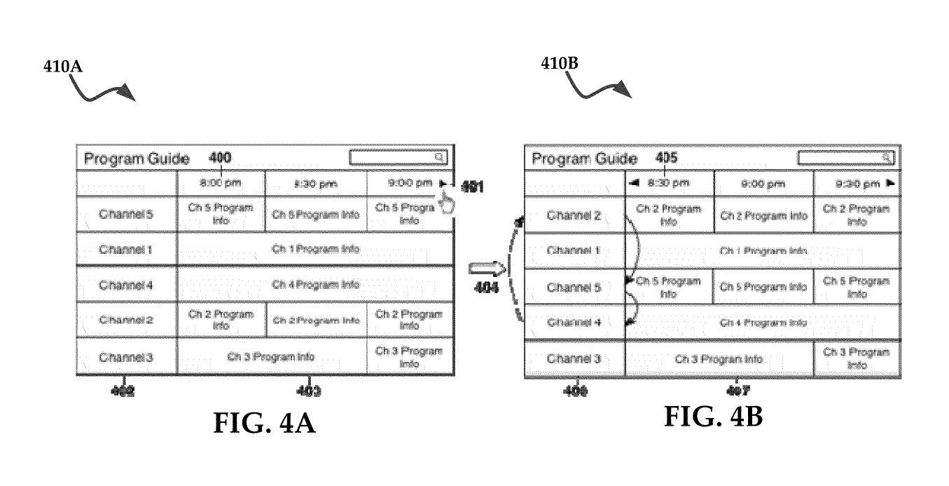

FIGS. 4A and 4B collectively illustrate personalized reprioritization of broadcast content across time slots in a program guide 410A and program guide 410B. The program guide 410A may comprise a plurality of time slots, such as time slot 400, which comprises a current time slot that comprises dynamically ranked broadcast content.

User selectable element 401 may allow the end user to navigate broadcast content forward to future time slots. The program guide 401A may also comprise a prioritized list of channels 402 for which programming is shown, as well as a scheduling matrix 403 for current and upcoming programming based on prioritized list.

Channel list reprioritization after time slot advancement is shown as arrow 404. The reprioritization may reflect user preferences based on a currently selected time slot, such as slot 405. The reprioritization also creates a newly reprioritized channel list 406 as well as a new scheduling matrix 407 for current and upcoming programming based on newly prioritized list.

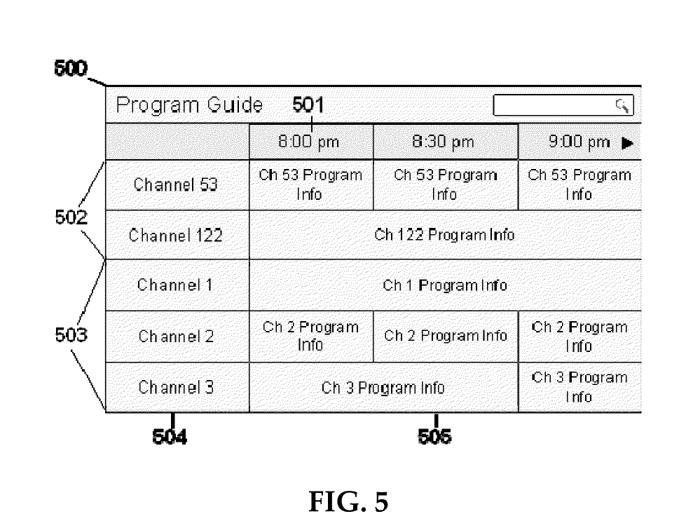

FIG. 5 illustrates allocation of personalized slots within a program guide 500. In some embodiments, the program guide 500 may comprise current time slots such as time slot 501 for which broadcast content is prioritized according to preference data. The program guide 500 may comprise multiple personalized channels 502 shown receiving top placement in the program guide 500. Multiple static slots 503 are shown in default sorting order placed underneath personalized channels 502. A column 504 of both prioritized and default sorted channels for which programming information is included in the program guide 500. Additionally, a scheduling matrix 505 for current and upcoming programming is also included in the program guide 500.

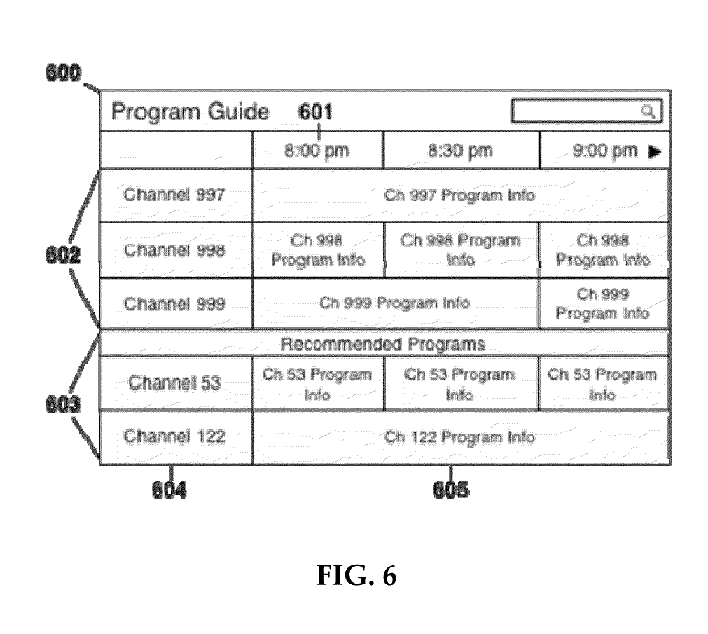

FIG. 6 illustrates the location of allocated and personalized slots within an exemplary program guide 600. In some exemplary embodiments, the program guide 600 may comprise time slots, such as current time slot 601 that comprises broadcast content that as been selected based upon end user preference data. The program guide 600 may comprise multiple channels 602 which are shown in default sorting order with top placement in the program guide 600. Multiple personalized channels 603 are shown in any one of various user assigned positions in within the program guide 600, currently shown in a lower placement relative to the static slots of the multiple channels 602. A column 604 relates to both prioritized and default sorted channels for which programming information is displayed in the program guide, as well as a scheduling matrix 605.

FIG. 7 illustrates an exemplary computing system 700 that may be used to implement an embodiment of the present systems and methods. The system 700 of FIG. 7 may be implemented in the contexts of the likes of computing systems, networks, servers, or combinations thereof. The computing system 700 of FIG. 7 includes one or more processors 710 and main memory 720. Main memory 720 stores, in part, instructions and data for execution by processor 710. Main memory 720 may store the executable code when in operation. The system 700 of FIG. 7 further includes a mass storage device 730, portable storage medium drive(s) 740, output devices 750, user input devices 760, a display system 770, and peripheral devices 780.

The components shown in FIG. 7 are depicted as being connected via a single bus 790. The components may be connected through one or more data transport means. Processor unit 710 and main memory 720 may be connected via a local microprocessor bus, and the mass storage device 730, peripheral device(s) 780, portable storage device 740, and display system 770 may be connected via one or more input/output (I/O) buses.

Mass storage device 730, which may be implemented with a magnetic disk drive or an optical disk drive, is a non-volatile storage device for storing data and instructions for use by processor unit 710. Mass storage device 730 may store the system software for implementing embodiments of the present invention for purposes of loading that software into main memory 720.

Portable storage device 740 operates in conjunction with a portable non-volatile storage medium, such as a floppy disk, compact disk, digital video disc, or USB storage device, to input and output data and code to and from the computer system 700 of FIG. 7. The system software for implementing embodiments of the present invention may be stored on such a portable medium and input to the computer system 700 via the portable storage device 740.

User input devices 760 provide a portion of a user interface. User input devices 760 may include an alphanumeric keypad, such as a keyboard, for inputting alpha-numeric and other information, or a pointing device, such as a mouse, a trackball, stylus, or cursor direction keys. Additional user input devices 760 may comprise, but are not limited to, devices such as speech recognition systems, facial recognition systems, motion-based input systems, gesture-based systems, and so forth. For example, user input devices 760 may include a touchscreen. Additionally, the system 700 as shown in FIG. 7 includes output devices 750. Suitable output devices include speakers, printers, network interfaces, and monitors.

Display system 770 may include a liquid crystal display (LCD) or other suitable display device. Display system 770 receives textual and graphical information, and processes the information for output to the display device.

Peripherals device(s) 780 may include any type of computer support device to add additional functionality to the computer system. Peripheral device(s) 780 may include a modem or a router.

The components provided in the computer system 700 of FIG. 7 are those typically found in computer systems that may be suitable for use with embodiments of the present invention and are intended to represent a broad category of such computer components that are well known in the art. Thus, the computer system 700 of FIG. 7 may be a personal computer, hand held computing system, telephone, mobile computing system, workstation, server, minicomputer, mainframe computer, or any other computing system. The computer may also include different bus configurations, networked platforms, multi-processor platforms, etc. Various operating systems may be used including Unix, Linux, Windows, Mac OS, Palm OS, Android, iOS (known as iPhone OS before June 2010), QNX, and other suitable operating systems.

It is noteworthy that any hardware platform suitable for performing the processing described herein is suitable for use with the systems and methods provided herein. Computer-readable storage media refer to any medium or media that participate in providing instructions to a central processing unit (CPU), a processor, a microcontroller, or the like. Such media may take forms including, but not limited to, non-volatile and volatile media such as optical or magnetic disks and dynamic memory, respectively. Common forms of computer-readable storage media include a floppy disk, a flexible disk, a hard disk, magnetic tape, any other magnetic storage medium, a CD-ROM disk, digital video disk (DVD), any other optical storage medium, RAM, PROM, EPROM, a FLASHEPROM, any other memory chip or cartridge.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. Exemplary embodiments were chosen and described in order to best explain the principles of the present technology and its practical application, and to enable others of ordinary skill in the art to understand the invention for various embodiments with various modifications as are suited to the particular use contemplated.

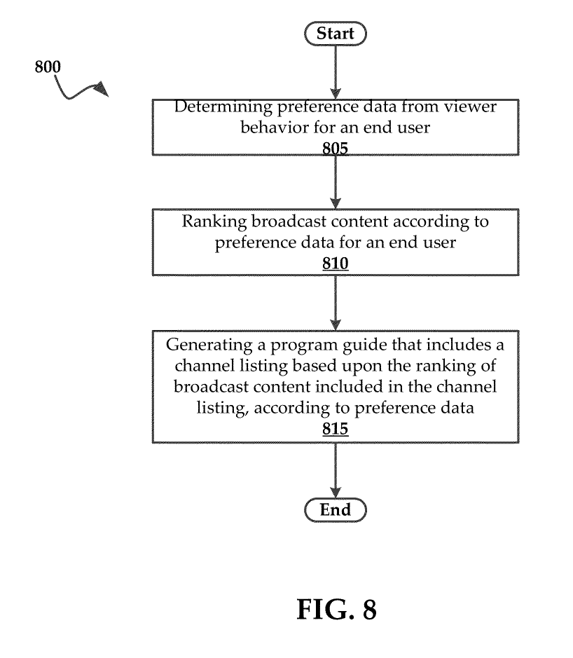

FIG. 8 is a flowchart of an exemplary method 800 for generating a program guide. The method 800 may comprise a step 805 of determining preference data from viewer behavior for an end user. The viewer behavior may be determined by evaluating both deliberate and/or incidental actions of the end user, such as those actions occurring on an end user computing device. Programs watched, watching duration, or other viewing preferences may be used to determine viewing behaviors for the end user. Viewing behavior may also comprise negative viewing behaviors (e.g., programs not watched, programs started and not finished, and so forth). Preference data may be extracted from these various types of viewing behavior.

Additionally, the method 800 may comprise a step 810 of ranking broadcast content according to preference data for an end user. Again, the broadcast content may be ranked in such a way that broadcast content which corresponds more closely to the preferences of the end user is ranked higher than broadcast content which corresponds less to the preferences of the end user.

According to some embodiments, the method 800 may comprise a step 815 of generating a program guide that includes a channel listing based upon the ranking of broadcast content included in the channel listing, according to preference data. More specifically, a plurality of channels in the channel listing comprise broadcast content. Thus, channels in the channel listing are ranked according to preference data for an end user relative to the broadcast content. It is envisioned that the program guide may comprise a visual representation, such as a matrix, where channels are listed hierarchically according to end user preference for broadcast content included in a plurality of the channels. The broadcast content may be placed into slots of the matrix, which may be arranged according to broadcast time.

Aspects of the present invention are described above with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While various embodiments have been described above, it should be understood that they have been presented by way of example only, and not limitation. The descriptions are not intended to limit the scope of the technology to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the technology as defined by the appended claims and otherwise appreciated by one of ordinary skill in the art. The scope of the technology should, therefore, be determined not with reference to the above description, but instead should be determined with reference to the appended claims along with their full scope of equivalents.

What is claimed is:

1. A method, comprising:
ranking, via a personalization system, broadcast content according to preference data for an end user, the broadcast content being ranked in such a way that broadcast content which corresponds more closely to the preferences of the end user is ranked higher than broadcast content which corresponds less to the preferences of the end user; and
generating a program guide that includes a visual representation of the broadcast content, which is hierarchically ranked according to the preference data.

2. The method according to claim 1, wherein preference data comprises viewing behaviors for the end user, and wherein the generating is performed via a user interface module.

3. The method according to claim 2, wherein viewing behaviors comprise any of a length of time an end user watches broadcast content, a time of day an end user watches broadcast content, days of the week an end user watches broadcast content, type of device an end user utilizes to watch broadcast content, a delivery method for broadcast content, and any combinations thereof.

4. The method according to claim 2, wherein viewing behaviors comprise broadcast content details which comprise any of actors, directors, producers, locations, date of origin, genre, synopsis, theme, mood, and any combinations thereof.

5. The method according to claim 2, wherein viewing behaviors comprise negative viewing behaviors.

6. The method according to claim 1, further comprising determining preference data from viewer behavior by receiving end user actions executed by an end user computing device.

7. The method according to claim 6, further comprising storing the preference data in an end user record which reside on a data store.

8. The method according to claim 1, wherein the program guide comprises dynamic slots that receive ranked broadcast content.

9. The method according to claim 8, wherein the program guide further comprises static slots.

10. A system, comprising:
at least one computing device comprising a memory that includes executable instructions and a processor executing the instructions, the instructions comprising:
a personalization engine that ranks broadcast content according to preference data for an end user, the broadcast content being ranked in such a way that broadcast content which corresponds more closely to the preferences of the end user is ranked higher than broadcast content which corresponds less to the preferences of the end user; and
a user interface module that generates a program guide that includes a visual representation of the broadcast content, which has been ranked according to the preference data.

11. The system according to claim 10, wherein preference data comprises viewing behaviors for the end user.

12. The system according to claim 11, wherein viewing behaviors comprise any of a length of time the end user watches broadcast content, a time of day the end user watches broadcast content, days of the week the end user watches broadcast content, type of device the end user utilizes to watch broadcast content, a delivery method for broadcast content, and any combinations thereof.

13. The system according to claim 11, wherein viewing behaviors comprise broadcast content details which comprise any of actors, directors, producers, locations, date of origin, genre, synopsis, theme, mood, and any combinations thereof.

14. The system according to claim 10, wherein viewing behaviors comprise negative viewing behaviors.

15. The system according to claim 10, wherein the personalization engine determines preference data from viewer behavior by analyzing end user actions executed by an end user computing device.

16. The system according to claim 15, wherein the personalization engine stores the preference data in an end user record which reside on a data store.

17. The system according to claim 10, wherein the program guide generated by the user interface module comprises dynamic slots that receive ranked broadcast content generated by the personalization engine.

18. The system according to claim 17, wherein the program guide further comprises static slots.

19. A method, comprising generating a program guide that includes a channel listing, a plurality of channels in the channel listing comprising broadcast content, wherein channels in the channel listing are ranked according to preference data for an end user relative to the broadcast content.

20. The method according to claim 19, wherein the broadcast content is hierarchically ranked according to the preference data.
